(19) United States
(12) Patent Application Publication
(10) Pub. No.: US 2008/0298803 A1
(43) Pub. Date: Dec. 4, 2008

(54) SYSTEM AND METHOD FOR PROTECTION OF POINT TO MULTIPOINT PASSIVE OPTICAL NETWORK

(75) Inventors: Tom Warner, Moraga, CA (US); Dumitru Gruia, San Ramon, CA (US); Joanne Maruca, Manteco, CA (US)

Correspondence Address: John Nielsen;RANDICK O'DEA & TOOLIATOS, LLP, 5000 HOPYARD ROAD, SUITE 400, PLEASANTON, CA, 94588, US

(73) Assignee: Alloptic, Inc.

(21) Appl. No.: 11/757,915

(22) Filed: Jun. 4, 2007

(51) Int. Cl. H04J 14/00

(52) U.S. Cl. 398/43

(57) ABSTRACT

A system and method relating to a point-to-multipoint Passive Optical Network (PON) that protects the system against fiber breaks or damage which can disrupt the path between the OLT and a plurality of Dual Transceiver ONUs.

### I. BACKGROUND OF THE INVENTION

A. Field of the Invention

The invention broadly relates to broadband telecommunications systems and particularly to those employing point-to-multipoint Passive Optical Networks (PON).

B. Prior Art

Currently there are broadband service providers deploying point-to-multipoint passive optical network systems to provide voice, data, and video services to customers. There are many point-to-multipoint PON technologies available today including Broadband PON (BPON), Gigabit Ethernet PON (GEPON), and Gigabit PON (GPON). Standards bodies such as the International Telecommunication Union (TTU) and Institute of Electrical and Electronics Engineers (IEEE) have released standards for PON systems.

Systems based on point-to-multipoint passive optical network (PON), (see FIG. 1) generally comprise an Optical Line Terminal (OLT) or Optical Line Termination (OLT) connected via fiber to a 1:n passive optical splitter, which in turn is connected to a plurality of Optical Network Units (ONUs) or Optical Network Terminals (ONTs). Optical Line Terminal and Optical Network Unit is the preferred naming convention for IEEE based PON, Optical Line Termination and Optical Network Terminal is the preferred naming convention in ITU 984.x PON. This invention is independent of the specific PON technology used at the OLT and ONU/ONT. For simplicity this specification will use the term Optical Line Terminal (OLT) and Optical Network Unit (ONU) to represent the typical elements of the PON system. Typical values for n are from 2 to 64 and typical distances from OLT to ONU are up to 20 km, though some PON systems can reach up to 60 km. The OLT contains an Optical Transceiver which transmits data downstream to the ONUs on an optical wavelength and receives data upstream on an optical wavelength from the ONUs. The ONU also contains an Optical Transceiver which transmits data upstream on an optical wavelength to the OLT and receives data downstream on an optical wavelength from the OLT. Data is broadcast downstream from the OLT and appears at all ONUs via the 1:n optical splitter. In the upstream direction, the ONUs use Time-Division-Multiple-Access (TDMA) to send data upstream to the OLT. Each ONU is assigned a timeslot in which it can send its upstream data to the OLT. This insures that data from multiple ONUs do not collide at the upstream output of the 1:n optical splitter. A PON system can function where there are only passive components between the OLT and ONU, i.e. there are no powered devices required. This allows PON systems to be a cost effective and reliable way to deliver telecommunications services.

Because of their cost effectiveness and ability to deliver high bandwidth to the end user, PON systems are being considered for the delivery of business services in addition to their more traditional use as residential service delivery platforms. Business services include high speed internet connections, high speed Ethernet transport such as transparent LAN service (TLS), Voice over Internet Protocol (VoIP), T1 delivery for PBXs, T1 backhaul for cell sites, and others. Business customers demand high availability of their service, i.e. minimum to no downtime. Because of this it is desirable for a PON system to provide the option of protection to those components of the system which may fail or be inadvertently damaged.

One general method to protect against a system failure is to deploy side-by-side duplicated systems, thus insuring that if one system fails, and the failure is detected, the other stand-by system will take over. This type of redundancy costs 2× the original equipment costs, often requires some kind of manual intervention to bring up the standby system, and is generally cost prohibitive.

Passive Optical Network (PON) systems, by their definition, require no active components in the optical distribution portion of the network—eliminating power failures in this portion of the network. With power eliminated as a failure mode in the optical distribution network, the next biggest contributor to downtime is fiber damage. Because PON systems can reach distances of up to 60 km, a fiber cut can be difficult to locate, and repair requires specially trained personnel and tools. Business service providers desire the option to protect against these faults in a cost effective manner. In another common scenario, the service provider provides telecommunications services to both residential and business customers from the same PON system. In this case, the service provider needs a cost effective way to provide services to both types of customers, with only paying the added expense of a protected system for the business customer. The optional protection provided by this invention solves these problems.

Fiber protection in point-to-multipoint passive optical network systems have been discussed before as described in Smith (US Patent Application No. 2005/0147410), “Method and System configured for providing passive optical network fiber protection.” This method differs from this application in significant ways. In this invention the entire fiber path from OLT to Dual Transceiver ONU is protected, whereas in US 2005/0147410 only a portion of the path is protected. In this invention Dual Transceiver ONUs are used to allow monitoring of both fiber paths at all times, whereas in US 2005/0147410 only the active path is monitored, in which case a failure to the inactive path can go undetected. Because this invention uses Dual Transceiver ONUs, protection switching is simplified in comparison to the more complicated switching at the OLT. Also, this invention shows a system which can simultaneously support protected Dual Transceiver ONUs as well as the less expensive unprotected Single Transceiver ONUs.

### II. BRIEF SUMMARY OF THE INVENTION

Accordingly, the objectives of the present system and apparatus are:
to provide cost effective redundancy in a PON system;
to provide a more durable broadband telecommunications system utilizing a PON; and
to provide a telecommunications system less vulnerable to service interruptions.

This invention provides for cost effective protection against fiber damage in a point-to-multipoint passive optical network system. In a point-to-multipoint passive optical network system (see FIG. 2) an Optical Line Terminal (OLT) 102 connects via fiber 103 to an upstream port of optical splitter 165 which connects to a plurality of Dual Transceiver ONUs via a plurality of fibers. Though not a requirement of the invention, the OLT 102, optical fiber 103, and optical splitter 105 are typically co-located in a Central Office or Cabinet 101. In this embodiment of the invention, customer services are protected from damage to any single fiber connecting a Dual Transceiver ONU to a downstream port of the optical splitter 105. Though not a requirement of the invention, the fiber cable connecting the Dual Transceiver ONUs to optical splitter 105 is typically part of the Outside Plant. The Outside Plant 100 comprises cable routes that reach from the Central Office or Cabinet 101 to Dual Transceiver ONUs (150-172) that typically reside inside the customers' premises. The premises may be a single family home, apartment building, hotel, place of business, or other structure where telecom equipment may be located. Fiber cable routes in the outside plant 100 are typically trenched cable ducts which follow streets and highways, or aerial routes on telephone or power poles. The fiber cable in the outside plant can reach lengths of up to 20 km in typical PON deployments systems and may reach distances of up to 60 km.

### III. BRIEF DESCRIPTION OF THE DRAWINGS

Exemplary embodiments are illustrated in referenced figures of the drawings. It is intended that the embodiments and figures disclosed herein are to be considered illustrative rather than restrictive.

FIG. 1 is a diagram illustrating a PON system generally known in the prior art.

FIG. 2 depicts a PON system in accordance with an embodiment of the disclosures made herein, which utilizes fibers emanating from an optical splitter for providing fiber protection functionality.

FIG. 3 depicts elements of a Dual Transceiver ONU in accordance with an embodiment of the disclosures made herein.

FIG. 4 depicts a PON system in accordance with an embodiment of the disclosures made herein, which utilizes fibers and optical splitters emanating from an optical splitter for providing fiber protection functionality.

FIG. 5 depicts a PON system comprising both Dual Transceiver ONUs and Single Transceiver ONUs.

FIG. 6 depicts a Single Transceiver ONU.

### IV. DETAILED DESCRIPTION OF THE INVENTION

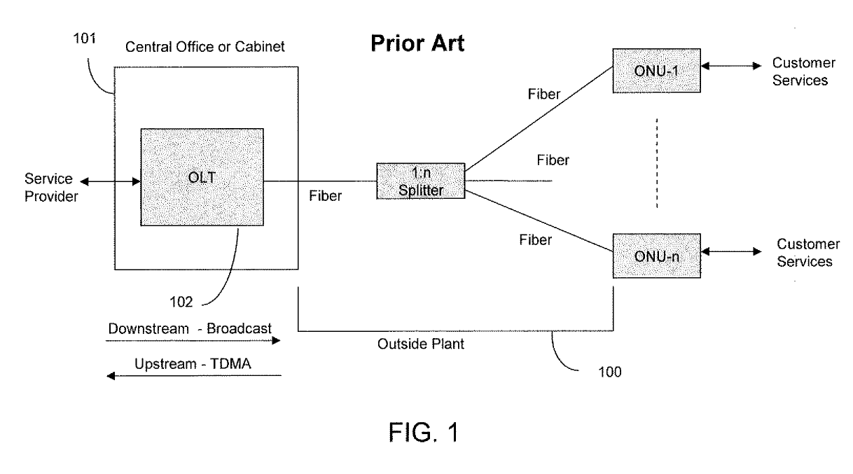

FIG. 1. A typical PON system as known in prior art comprising an OLT, a 1:n optical splitter, and a plurality of ONUs connected to the OLT via the 1:n optical splitter. The OLT is generally located in the Central Office of the Telecommunications service provider or in a Cabinet designed to contain Telecommunications equipment. The ONU is typically located at the customer premise. The customer premise may be a single family home, apartment building, hotel, place of business, or other structure where telecom equipment may be located. The ONU is typically installed inside the home or building or attached to the outside of the home or building.

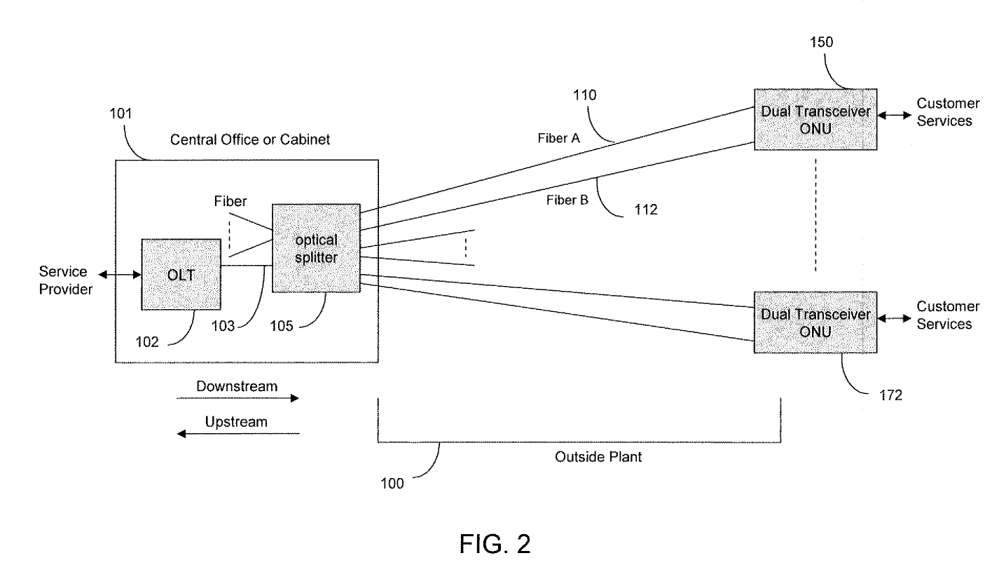

FIGS. 2 & 3. An embodiment of the invention comprises an OLT 102 connected to an upstream port of optical splitter 105 by fiber 103. The OLT 102, optical splitter 105, and fiber 103 are typically co-located in a Central Office or Cabinet 101. Fiber 103 from the OLT 102 to the optical splitter 105 is typically a few meters in length and is well protected from damage. Downstream ports of optical splitter 105 connect to a plurality of Dual Transceiver ONUs (150-172). Each Dual Transceiver ONU contains two optical transceivers and connects by two fibers to downstream ports of the optical splitter 105. Although not required by this invention, the fiber between the Central Office or Cabinet 101 and the Dual Transceiver ONUs (150-172) are typically installed in the Outside Plant 100. In the Outside Plant the fiber cables are typically housed in buried cable ducts which follow streets and highways, or aerial routes on telephone or power poles and are subject to damage by construction equipment, flooding, storm damage, earthquakes, or other man-made or natural causes. Although not required by the invention, the two fibers connecting the Dual Transceiver ONUs to optical splitter 105 are typically installed in separate fiber ducts and run along separate physical paths to avoid the case where both fibers are damaged by a single cause or fault.

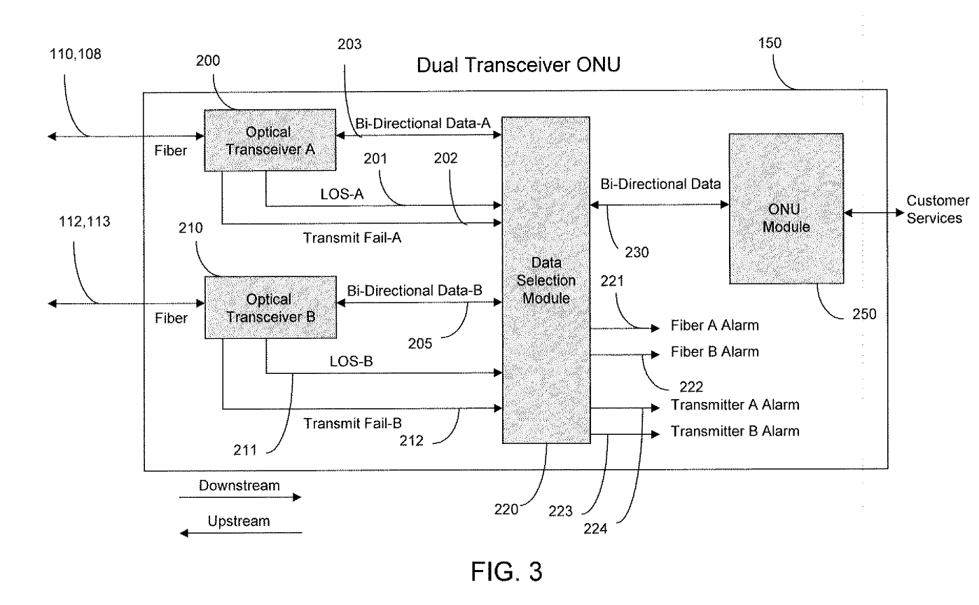

A Dual Transceiver ONU is shown in FIG. 3. The Dual Transceiver ONU 150 comprises two Optical Transceivers 200 and 210, a Data Selection Module 220, and an ONU Module 250, The Optical Transceivers typically perform the function of, in the downstream direction (from OLT to ONU), converting optical signals into electrical signals, and in the upstream direction (ONU to OLT) converting electrical signals into optical signals. The Data Selection Module should perform the function of selectively connecting Bi-Directional Data-A 203 or Bi-Directional Data-B 205 to Bi-Directional Data 230, providing fiber alarm outputs (221 and 222), and providing Transmitter Alarm outputs (223 and 224). The ONU Module 250 comprises all of the other typical functions of an ONU as used in a point-to-multipoint passive optical network and is well known in the art. This may include media-access-control (MAC), switching functionality, alarm management, service provisioning, user interfaces, etc.

An example of system recovery from a single fiber fault on a fiber connected to Dual Transceiver ONU 150 is as follows. In a non-fault condition, the OLT 102 (see FIG. 2) transmits optical data downstream to an upstream port of the optical splitter 105 which splits the signal and sends the optical signal out its downstream ports. One of the downstream ports of the optical splitter 105 is connected via Fiber A 110 to Optical Transceiver A 200 (FIG. 3) of the Dual Transceiver ONU 150. Another of the downstream ports of the optical splitter 105 is connected via Fiber B 112 to Optical Transceiver B 210 of the Dual Transceiver ONU 150. Referring to the detailed diagram of the Dual Transceiver ONU 150 (FIG. 3), and under a no-fault operating condition (e.g. all fiber undamaged) the Loss of Signal-A (LOS-A) 201 and Loss of Signal-B (LOS-B) 211 signals from Optical Transceiver A 200 and Optical Transceiver B 210 respectively, will be negative, indicating that an acceptable optical signal is being received from both Fiber A 10 and Fiber B 112. With the Loss of Signal indicators, LOS-A 201 and LOS-B 211 negative, the Data Selection Module 220 will connect Bi-Directional Data-A 203 to Bi-Directional Data 230 which is connected to the ONU Module 250. Data transmission in the system is bi-directional, so under no-fault operating conditions, the ONU Module 250 can also send data upstream to the OLT via Data Selection Module 220, Optical Transceiver A 200, Fiber A 110, optical splitter 105, and fiber 103.

If a fault or other interruption occurs in Fiber A 110 which causes the optical signal carried by the fiber to be lost or significantly degraded, the LOS-A 201 signal will go positive, indicating to the Data Selection Module 220 that an unacceptable signal is being received on Fiber A 110. Bi-Directional Data-A 203 will be lost and temporarily there will be a loss of Bi-Directional Data 230 to the ONU Module 250 and the Dual Transceiver ONU 150 will stop providing service to the customer. Based on the state of the LOS-A 201 signal being positive, the Data Selection Module 220 will switch to receive/transmit data from Optical Transceiver B 210 using Bi-Directional Data-B 205 and restore Bi-Directional Data 230 to the ONU Module 250. The Data Selection Module 220 will also activate the Fiber A Alarm 221. The Fiber A Alarm 221 will be used to alert the service provider that a fiber fault has occurred on Fiber A and that corrective action to repair the fault should be started. With data restored to the ONU Module 250, the ONU Module 250 will start to restore service. In the downstream direction, very soon after the switch is made to Optical Transceiver B 210, the downstream data flow is restored. In the upstream direction (Dual Transceiver ONU to OLT) though, it can not be assumed that the Dual Transceiver ONU can continue to send data in the same timeslot as it used prior to the fault in the fiber. This is due to the fact that the length of Fiber A 110 will likely be significantly different than the length of Fiber B 112. This is due to the typical diverse routing of the fiber between the Central Office or Cabinet and the Dual Transceiver ONUs. Using the same timeslot assigned to this Dual Transceiver ONU prior to the fault may result in upstream collisions with other Dual Transceiver ONUs connected to the same OLT. Instead the ONU Module 250, together with the OLT 102, will re-calculate the Dual Transceiver ONU transmit timeslot. Once this is completed, fill bi-directional data can be restored and the customer's services restored.

Another advantage of this invention is that both Fibers A and B are continuously monitored for faults. The Data Selection Module 220 is always monitoring the LOS-A 201 signal and the LOS-B signal 211. If there is a fault on either Fiber A or Fiber B or both, the Fiber Alarms 221 and 222 will go active and be used to alert the service provider that a fiber fault has been detected and that corrective action should be taken.

In addition to protecting against fiber failures, the Dual Transceiver ONU 150 also protects against a failure of the transmitters in either of the Optical Transceivers 200 and 210 of the Dual Transceiver ONU. The Data Selection Module 220 monitors the signals Transmit Fail-A 202 and Transmit Fail B 212. Under normal conditions, both Transmit Fail A and Transmit Fail B are negative, indicating that both transmitters are in good working condition. In this condition the Data Selection Module 220 will connect Bi-Directional Data-A 203 to Bi-Directional Data 230. If, under these conditions, the signal Transmit Fail-A goes positive, indicating a failure with Optical Transceiver A's transmitter, the Data Selection Module will switch to Optical Transceiver B and connect Bi-Directional Data-B 205 to Bi-Directional Data 230, and activate the Transmitter A Alarm 224. As with a fiber failure on Fiber A, the ONU Module will now receive its downstream data from Fiber B , and will start the process to re-calculate the time-slot on which to transmit data to the OLT using Fiber B. The Transmitter A Alarm 224 will be used to alert the service provider that the Dual Transceiver ONU has had a failure on Transmitter A and that corrective action is needed. In a like manner, if Transmitter Fail-B 212 goes active, indicating that the transmitter of Optical Transceiver B 210 has failed, a Transmitter B Alarm 223 will be generated and used to alert the service provider that corrective action is needed.

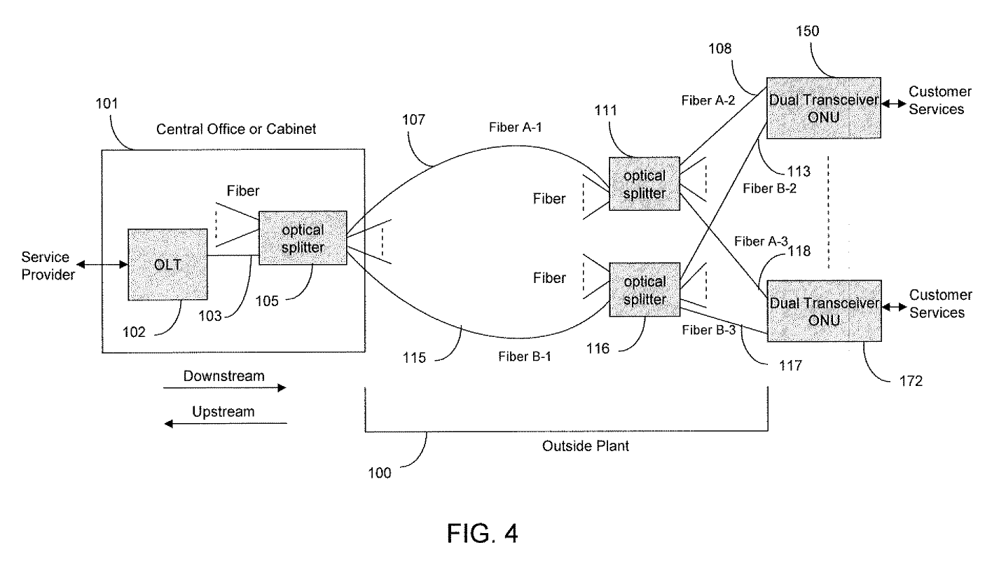

FIG. 4. Another embodiment of the invention comprises an OLT 102 connected to an upstream port of optical splitter 105 by fiber 103. The OLT 102, optical splitter 105, and fiber 103 are typically co-located in a Central Office or Cabinet 101. Fiber 103 from the OLT 102 to optical splitter 105 is typically a few meters in length and is well protected from damage. A downstream port of the optical splitter 105 connects via Fiber A-1 107 to an upstream port of optical splitter 111. Another downstream port of optical splitter 105 connects via Fiber B-1 115 to an upstream port of optical splitter 116. Connected to the downstream ports of optical splitter 111 and optical splitter 116 are a plurality of Dual Transceiver ONUs (150-172). Each Dual Transceiver ONU contains two optical transceivers and has a fiber connection to both optical splitters 111 and 116. Although not required by the invention, the fiber and optical splitters between the Central Office or Cabinet 101 and the Dual Transceiver ONUs (150-172) are typically installed in the Outside Plant 100. The Outside Plant comprises the fiber cable and optical splitters which lie between the Central Office or Cabinet and the customer location. The Fiber cables are typically housed in buried cable ducts which follow streets and highways, or aerial routes on telephone or power poles and are subject to damage by construction equipment, flooding, storm damage, earthquakes, or other man-made or natural causes. The optical splitters are typically mounted in enclosures in buried vaults or on poles.

Although not a requirement of the invention, Fibers A-1 107, A-2 108, and A-3 118 are preferably placed in different fiber ducts than Fibers B-1 115, B-2 113, and B-3 117 to preclude a single fault severing both cable sets.

Also, the invention will work with any combination of fiber lengths for Fibers A-1, A-2, A-3 and fibers B-1, B-2, B-3 as long as the total distance from OLT to any Dual Transceiver ONU is kept under the PON system design limits.

An example of system recovery from a single fiber fault on a fiber connected to Dual Transceiver ONU 150 is as follows. In a non-fault condition, the OLT 102 (see FIG. 2) transmits optical data downstream to an upstream port of optical splitter 105 which splits the signal and sends the optical signal out its downstream ports. One of the downstream ports of optical splitter 105 is connected via Fiber A-1 107 to optical splitter 111. Another of the downstream ports of optical splitter 105 is connected via Fiber B-1 115 to optical splitter 116. Optical splitters 111 and 116 divide the optical signal and make it available at their downstream ports. Dual Transceiver ONUs connect via fiber to one downstream port of each optical splitter 111 and 116.

Dual Transceiver ONU 150 is an example of one of the plurality of Dual Transceiver ONUs connected to optical splitters 111 and 116. Referring to the detailed diagram of Dual Transceiver ONU 150 (FIG. 3), and under no fault conditions (e.g. all fiber undamaged) the Loss of Signal-A (LOS-A) 201 and Loss of Signal-B (LOS-B) 211 signals from Optical Transceiver A 200 and Optical Transceiver B 210 respectively, will be negative, indicating that an acceptable optical signal is being received from both Fiber A-2 108 and Fiber B-2 113. With the Loss of Signal indicators, LOS-A 201 and LOS-B 211 negative, the Data Selection Module 220 will connect Bi-Directional Data-A 203 to Bi-Directional Data 230 to the ONU Module 250. Data transmission in the system is bi-directional, so under no-fault operating conditions, the ONU Module will also send data upstream to the OLT via Data Selection Module 22O, Optical Transceiver A 200, Fiber A-2 108, optical splitter 111, Fiber A-1 107, optical splitter 105, and fiber 103.

If a fault occurs in Fiber A-1 107, Fiber A-2 108, or splitter 111 which causes the optical signal into Optical Transceiver-A 200 to be unacceptable, the LOS-A 201 signal will go positive, indicating to the Data Selection Module 220 that an unacceptable optical signal is being received on Fiber A-2 108. Bi-Directional Data-A 203 will be lost and temporarily there will be a loss of Bi-Directional Data 230 to the ONU Module 250 and the Dual Transceiver ONU 150 will stop providing service to the customer. Based on the state of the LOS-A 201 signal being positive, the Data Selection Module 220 will switch to receive/transmit data from Optical Transceiver B 210 using Bi-Directional Data-B 205 and restore Bi-Directional Data 230 to the ONU Module 250. The Data Selection Module 220 will also raise the Fiber A Alarm 221. The Fiber A Alarm 221 will be used to alert the service provider that a fiber fault has occurred on Fiber path A and corrective action should be started. With data restored to ONU Module 250, the ONU Module 250 will start to restore service. In the downstream direction, very soon after the switch is made to Optical Transceiver B 210, the downstream data flow is restored. In the upstream direction (Dual Transceiver ONU to OLT) though, it can not be assumed that the Dual Transceiver ONU can continue to send data in the same timeslot as it used prior to the fault in the fiber. This is due to the fact that fiber length along path A, i.e. Fiber A-1 107 and Fiber A-2 108, will likely be significantly different than the fiber length along path B, i.e. Fiber B-1 115 and Fiber B-2 113. This is due to the diverse routing of the fiber between the Central Office or Cabinet and the Dual Transceiver ONUs. Using the same timeslot assigned to this Dual Transceiver ONU prior to the fault may result in upstream collisions with other Dual Transceiver ONUs connected to the same OLT. Instead the ONU Module 250, together with the OLT 102, will re-calculate the Dual Transceiver ONU transmit timeslot. Once this is completed, fill bi-directional data can be restored and the customer's services restored.

Another advantage of this invention is that both of the Fiber paths A and B are always monitored for faults. The Data Selection Module 220 (FIG. 3) is always monitoring the LOS-A 201 signal and the LOS-B signal 211. If there is a fault on either fiber path A or fiber path B, the respective Fiber Alarms 221 or 222 will go active and be used to alert the service provider that a fiber fault has been detected and corrective action should be taken.

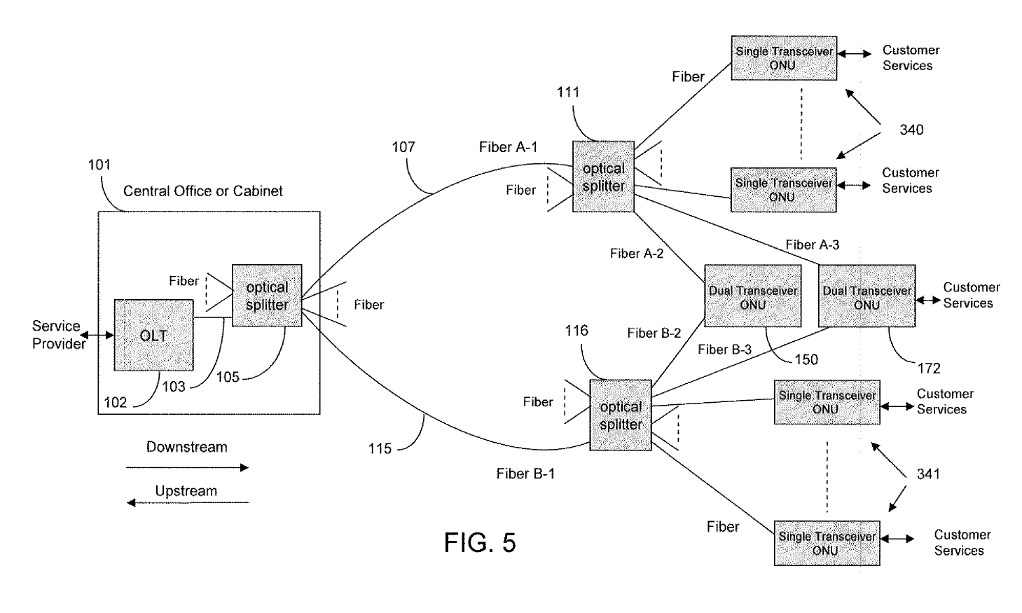

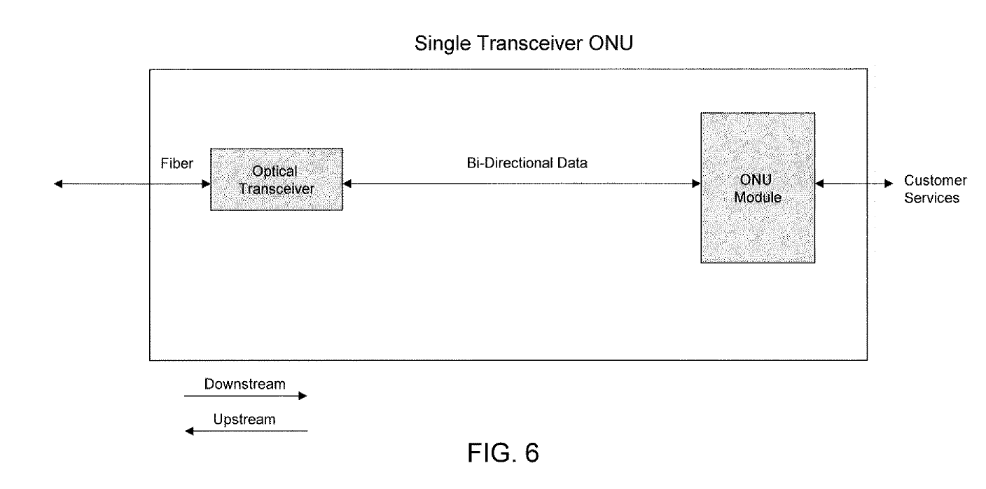

FIGS. 5 & 6. FIG. 5 illustrates an embodiment where the service provider supports a plurality of non-fiber protected Single Transceiver ONUs (see FIG. 6) and a plurality of fiber protected Dual Transceiver ONUs from the same OLT. This may be the case when there is a mix of residential and business customers served from the same OLT and the service provider desires to use a Single Optical Transceiver ONU for the residential subscribers, for cost savings purposes, and offer improved protection against fiber faults for the business customers. This embodiment differs from FIG. 4 in that the optical splitter 111 and optical splitter 116 have both a plurality of Dual Transceiver ONUs (150-172) and a plurality of Single Transceiver ONUs 340 and 341 connected to their downstream ports. For the Single Transceiver ONUs, any failure in the fiber path connecting them to the OLT will result in a loss of customer services to the customers connected to that Single Transceiver ONU. The additional Single Transceiver ONUs 340 and 341 have no affect on the system operation as previously described for Dual Transceiver ONUs. In this way both Single Transceiver ONUs (not protected from fiber faults) and Dual Transceiver ONUs (protected from fiber faults) can be deployed from the same OLT.

We claim:

1. A point-to-multipoint passive optical network (PON) system comprising:
a. an Optical Line Terminal (OLT);
b. a first optical splitter with at least one upstream port and a plurality of downstream ports;
c. an optical fiber connecting the OLT to at least one upstream port of the first optical splitter;
d. a plurality of Dual Transceiver Optical Network Units each connected by fiber to two downstream ports of the first optical splitter;
e. the Dual Transceiver Optical Network Units comprising:
i. Two Optical Transceivers;
ii. an ONU Module;
iii. a Data Selection Module configured for facilitating the selection of bi-directional data between the Optical Transceivers and the ONU module based on availability of optical signal into the optical transceivers;
iv. a plurality of connections between each Optical Transceiver and the Data Selection Module; and
v. a connection between the Data Selection Module and the ONU Module;

2. The system of claim 1 wherein the OLT, first optical splitter, and the fiber connecting the OLT to an upstream port of the first optical splitter are housed in a central office.

3. The system of claim 1 wherein the OLT, first optical splitter, and the fiber connecting the OLT to an upstream port of the first optical splitter are housed in a cabinet.

4. The system of claim 1 further comprising one or more additional optical splitters functionally connected between the first optical splitter and the Dual Transceiver ONUs, wherein each additional optical splitter has at least one connection to a downstream port of the first optical splitter and connects to a plurality of Dual Transceiver ONUs.

5. The system of claim 1 where the PON system is based on IEEE-802.3.

6. The system of claim 1 where the PON system is based on ITU-984.x.

7. The system of claim 1 wherein the Data Selection Module farther comprises a failure notification function for loss of signal to an optical transceiver.

8. The system of claim 3 further comprising a plurality of Single Transceiver ONUs connected to the one or more additional optical splitters functionally connected between the first optical splitter and the Dual Transceiver ONUs.

9. A method of installing a point-to-multipoint passive optical network (PON) system comprising:
a. installing an Optical Line Terminal (OLT);
b. installing a first optical splitter with at least one upstream port and a plurality of downstream ports;
c. installing an optical fiber connecting the OLT to at least one upstream port of the first optical splitter; and
d. Installing a plurality of Dual Transceiver Optical Network Units each connected by fiber to two downstream ports of the first optical splitter, wherein the Dual Transceiver Optical Network Units comprises.
i. Two Optical Transceivers;
ii. an ONU Module;
iii. a Data Selection Module configured for facilitating the selection of bi-directional data between the Optical Transceivers and the ONU module based on availability of optical signal into the optical transceivers;
iv. a plurality of connections between each Optical Transceiver and the Data Selection Module; and
v. a connection between the Data Selection Module and the ONU Module.
